(19) United States
(12) Patent Application Publication
(10) Pub. No.: US 2013/0186490 A1
(43) Pub. Date: Jul. 25, 2013

(54) Nozzle Head for Air Pump

(71) Applicant: Scott Wu, Taichung City (TW)

(72) Inventor: Scott Wu, Taichung City (TW)

(21) Appl. No.: 13/353,408

(22) Filed: Jan. 19, 2012

(51) Int. Cl. G05D 16/00

(52) U.S. Cl. 137/613

(57) ABSTRACT

A nozzle head includes a housing, an activating member, and a cap. The housing is engagable with a pumping mechanism of an air pump. The housing includes a passage and also includes a first end adapted for receiving an American valve and a second end adapted for receiving a French valve respectively. The activating member is disposed in the housing and movable to a first position in which the housing includes the first end in fluid communication with the passage and the second end not in fluid communication with the passage and a second position in which the housing includes the second end in fluid communication with the passage and the first end not in fluid communication with the passage. The cap is fitted to the first end of the housing and rotatable with respect thereto.

### BACKGROUND OF THE INVENTION

1. Field of the Invention

The present invention relates to a nozzle head for an air pump.

2. Description of the Related Art

U.S. Pat. No. 5,921,269 and DE 102008057713 to the applicant each shows a nozzle head engagable with an air pumping mechanism, which can then be used to pump air into a tire or a shock absorber. Moreover, the nozzle head is compatible to an American valve and a French valve. In order to be convenient, each of these nozzle heads is a “two-head” design, with one head for an American valve and the other for a French valve. However, it is still desirable to invent a nozzle head that can engage with any valves in a secure and airtight manner.

The present invention is, therefore, intended to obviate or at least alleviate the problems encountered in the prior art.

### SUMMARY OF THE INVENTION

According to the present invention, a nozzle head for an air pump is capable of engaging with different kinds of valves and includes a housing, an activating member, and a cap. The housing includes a first extension extended from a first end to a second end, and a second extension extending transversely from the first extension. The housing is engagable with a pumping mechanism of an air pump, which connects to the second extension. The first extension delimits a first chamber extended therethrough. The second extension delimits a passage in fluid communication with the first chamber. The first chamber is extended from the first end to the second end of the housing. The first end of the housing is adapted for receiving an American valve, with the nozzle head and the American valve adapted to be airtightly engaged with each other in thread engagement. The second end of the housing is adapted for receiving a French valve, with the nozzle head and the French valve adapted to be airtightly engaged with each other in non-thread engagement. The activating member is disposed in the first chamber and movable axially therein. The activating member defines a first section and a second section, with the first and second sections for abutting against different valves. The first section of the activating member delimits a second chamber, which includes a valve stem and an air seal disposed therein. The valve stem is adapted for abutting against the American valve. The air seal is adapted to be pressed by the American valve and achieve an airtight effect. The activating member movable to a first position in which the housing includes the first end in fluid communication with the passage and the second end not in fluid communication with the passage and a second position in which the housing includes the second end in fluid communication with the passage and the first end not in fluid communication with the passage. The cap is fitted to the first end of the housing and rotatable with respect thereto. Also, the American valve engaged with the nozzle head is in thread engagement with the cap.

It is an object of the present invention to provide a nozzle head that can engage with different kinds of valves in a secure and airtight manner.

It is another object of the present invention to provide a nozzle head for an air pump, which can then be used to pump air into a tire or a shock absorber.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a nozzle head for an air pump in accordance with a first embodiment of the present invention.

FIG. 2 is an exploded perspective view of the nozzle head of FIG. 1.

FIG. 3A is a cross-sectional view of the nozzle head of FIG. 1.

FIG. 3B is a cross-sectional view taken along line 3B-3B of FIG. 3A.

FIG. 4 is a cross-sectional view showing the nozzle head of FIG. 1 engaged with a French valve of a tire and arrows indicating air.

FIG. 5 is a cross-sectional view showing the nozzle head of FIG. 1 engaged with an American valve of a tire and arrows indicating air.

FIG. 6 is a cross-sectional view of a nozzle head for an air pump in accordance with a second embodiment of the present invention.

FIG. 7A is a cross-sectional view of a nozzle head for an air pump in accordance with a third embodiment of the present invention.

FIG. 7B is a cross-sectional view taken along line 7B-7B of FIG. 7A.

FIG. 8 is a cross-sectional view of a nozzle head for an air pump in accordance with a fourth embodiment of the present invention.

FIG. 9 is a cross-sectional view of a nozzle head for an air pump in accordance with a fifth embodiment of the present invention.

### DETAILED DESCRIPTION OF THE PREFERRED EMBODIMENTS

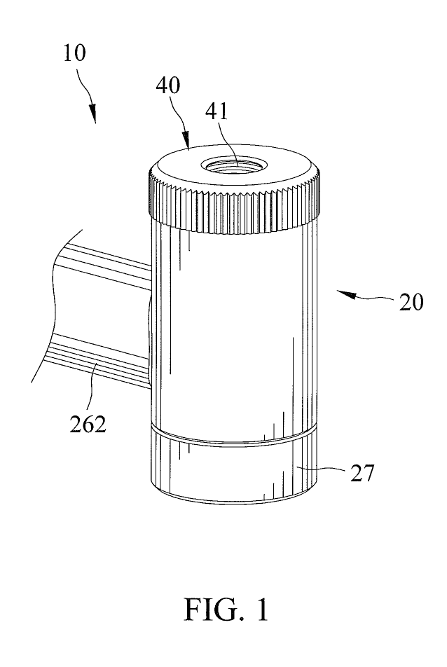

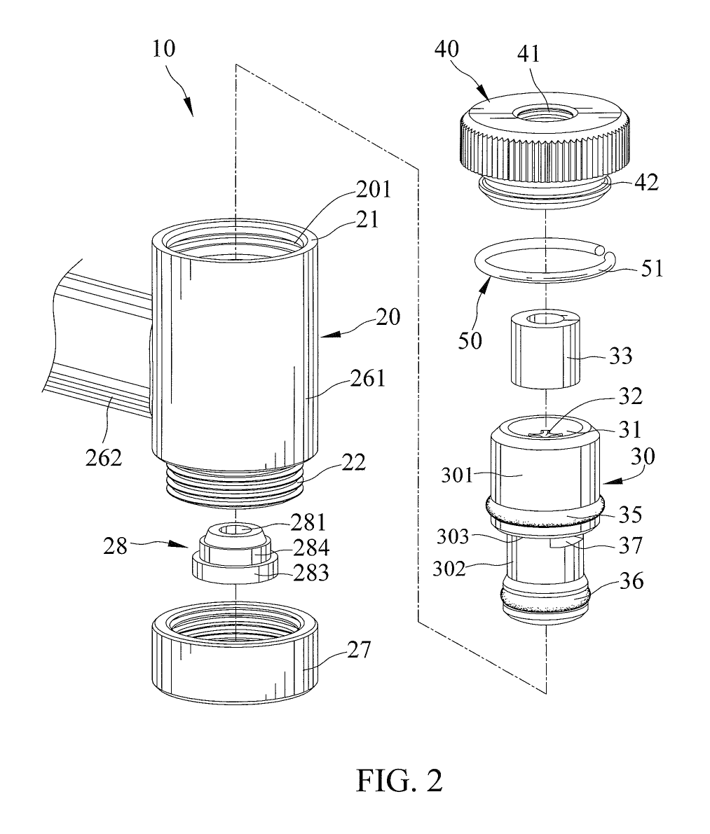

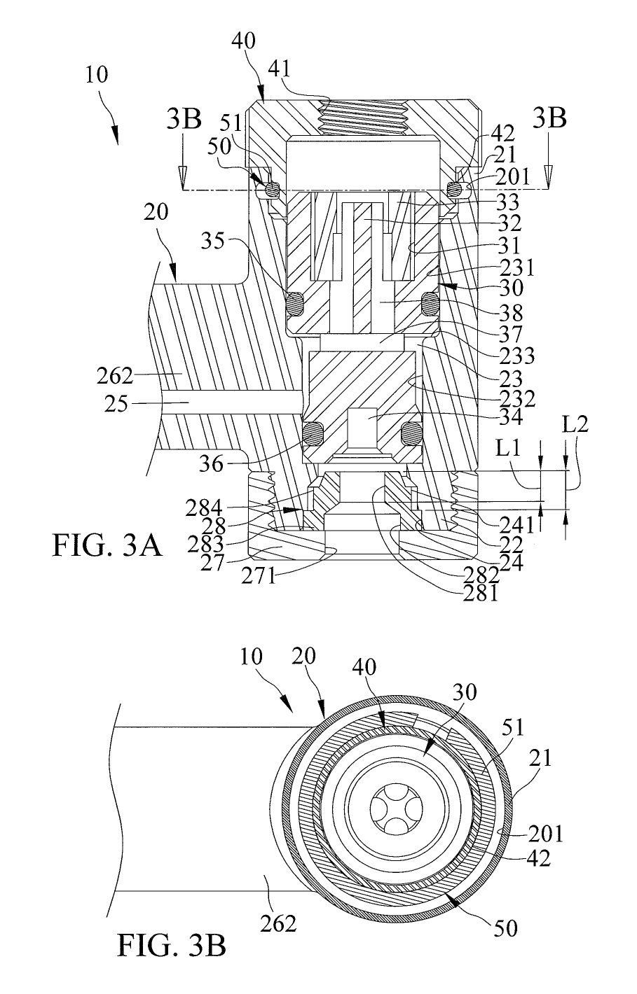

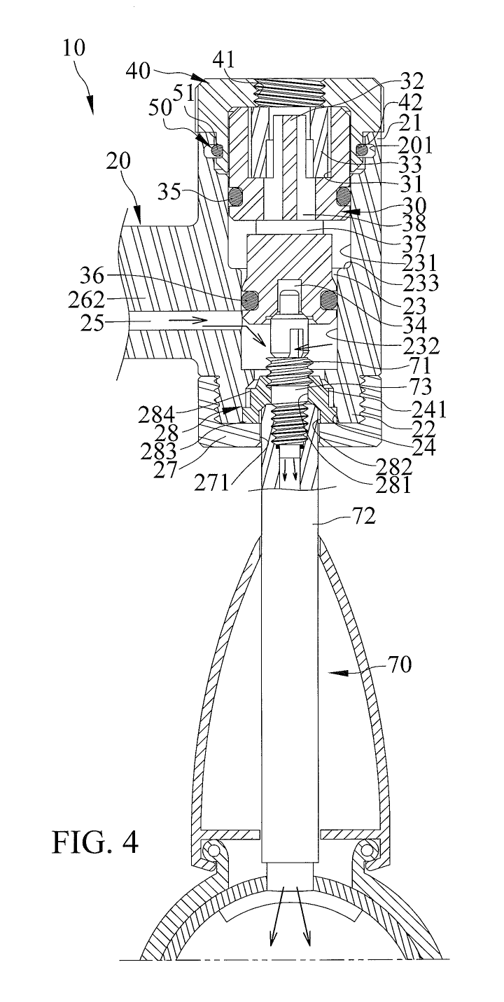

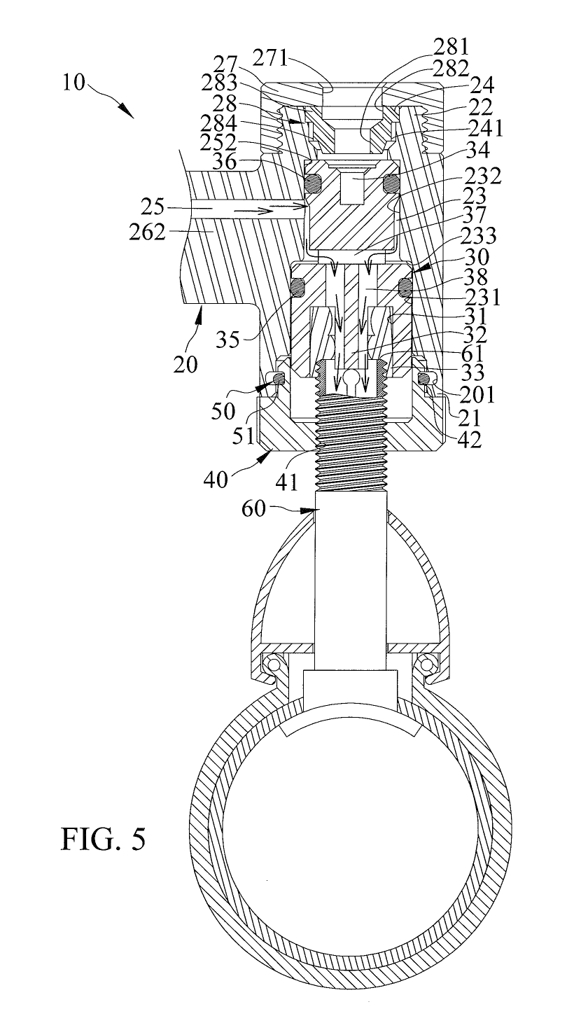

Referring to the FIGS. 1 through 5, a nozzle head 10 for an air pump in accordance with a first embodiment of the present invention includes a housing 20, an activating member 30, and a cap 40.

The housing 20 includes a first extension 261 and a second extension 262 extending transversely from the first extension 261. The first extension 261 delimits a first chamber 23 extended therethrough. The first chamber 23 defines larger and smaller chamber sections 231 and 232. The larger chamber section 231 is larger in diametrical size than the smaller chamber section 232. Further, a stop wall 233 is extended from a periphery of the larger chamber section 231 to a periphery of the smaller chamber section 232. The first chamber 23 is extended from a first end 21 to a second end 22 of the housing 20, and the first end 21 is adapted for receiving an American valve 60 and the second end 22 is adapted for receiving a French valve 70 respectively, with the first end 21 and the American valve 60 adapted to be airtightly engaged with each other in thread engagement, with the second end 22 and the French valve 70 adapted to be airtightly engaged with each other in non-thread engagement. The first chamber 23 defines a receiving section 24 at the second end 22 of the housing 20, with the receiving section 24 receiving a seal ring 28, which is adapted for air-tightly surrounding and non-threadly engaging with the French valve 70, as well as allows the French valve 70 to be able to be abutted against the second section 302 of the activating member 30. The seal ring 28 delimits a throughhole 281 for receiving the French valve 70 and defines a fitting section 283 and a restraining section 284, with the fitting section 283 abutted against a wall delimiting the receiving section 24 and the restraining section 284 spaced from the wall and defining a gap 241, which allows air to be able to flow thereinto, thereby forcing the restraining section 284 to depress an outer periphery of the French valve 70 radially and enabling the French valve 70 to be air-tightly surrounded and securely held by the seal ring 28. The throughhole 281 has a diametrical size smaller than that measuring the outer periphery of the French valve 70. Further, section of the throughhole 281 delimited by the restraining section 284 defines a first hole section adapted for surrounding a neck 73 of the French valve 70, which separates smaller and larger outer peripheral sections 71 and 72 of the French valve 70. The smaller outer peripheral section 71 defines a thread section. Further, section of the throughhole 281 delimited by the fitting section 283 defines a space 282 having a diametrical size larger than a diametrical size of the first hole section and such that the French valve 70 engaged in the throughhole 281 includes the larger outer peripheral section 72 stopped in an area between the first hole section and the space 282 and prevented from being inserted in the first hole section. Moreover, the seal ring 28 includes the first hole section of the throughhole 281 extended in a first direction and having a first longitudinal length L1 greater than that measuring a longitudinal length of the neck 73. Moreover, the seal ring 28 includes the restraining section 284 having a second longitudinal length L2 in the first direction, which is greater than the first longitudinal length L1. The second extension 262 delimits a passage 25 in fluid communication with the first chamber 23. The housing 20 is engagable with a pumping mechanism of an air pump, which connects to the second extension 262. Further, a cover 27 fitted to the second end 22 of the housing 20 and delimiting a first aperture 271 adapted for an insertion of the French valve 70. The first aperture 271 is in fluid communication with the second chamber 23. The housing 20 and the cover 27 can be made integrally as one piece.

The activating member 30 is disposed in the first chamber 23 and movable axially therein and defines a first section 301 and a second section 302. The first and second sections 301 and 302 are used for abutting against different valves. The first section 301 delimits a second chamber 31, which includes a valve stem 32 and an air seal 33 disposed therein. The valve stem 32 is adapted for abutting against the American valve 60 and the air seal 33 adapted to be pressed by a distal end 61 of the American valve 60 and achieve an airtight effect. The activating member 30 is movable to a first position in which the housing 20 includes the first end 21 in fluid communication with the passage 25 and the second end 22 not in fluid communication with the passage 25 and a second position in which the housing 20 includes the second end 22 in fluid communication with the passage 25 and the first end 21 not in fluid communication with the passage 25. The activating member 30 includes the first section 301 received in the larger chamber section 231 and the second section 302 received in the smaller chamber section 232 respectively. The first section 301 is shorter in length than the larger chamber section 231 and larger in diametrical size than the second section 302. Moreover, the activating member 30 includes an outer periphery including a first and second O-rings 35 and 36 fitted thereon to prevent air leaks, a first conduit 37 extended therein and including an opening on the outer periphery, and a second conduit 38 in communication with the first conduit 37 and extending from the first conduit 37 to the second chamber 31. The second O-ring 36 is movable to the left and right sides of the passage 25. One of the first and second O-rings 35 and 36 is disposed to the left side of the conduit 37 and the other disposed to the right side of the conduit 37 respectively. Further, a shoulder 303 is formed and extended from a periphery of the first section 301 to a periphery of the second section 302. The shoulder 303 is abutted against the stop wall 233 to stop the first section 301 from trespassing into the smaller chamber section 232.

The cap 40 is fitted to the first end of the housing and rotatable with respect thereto, with the American valve in thread engagement with the cap 40. The cap 40 delimits a second aperture 41 with a threaded periphery adapted for threadly receiving the American valve 50. The second 41 aperture is in fluid communication with the second chamber 23. The second aperture 41 has a diametrical size larger than the larger outer peripheral section 72 of the French valve 70.

Furthermore, the housing 20 includes a periphery defining a first section and the cap 40 includes a periphery defining a second section respectively, with the first and second sections abutted against each other circumferentially, with the first section including a first coupling end 201 defined thereon and the second section including a second coupling end 42 defined thereon respectively, with the first and second coupling ends 201 and 42 forming two slots. Also, the first section has a diameter smaller than that of the second section.

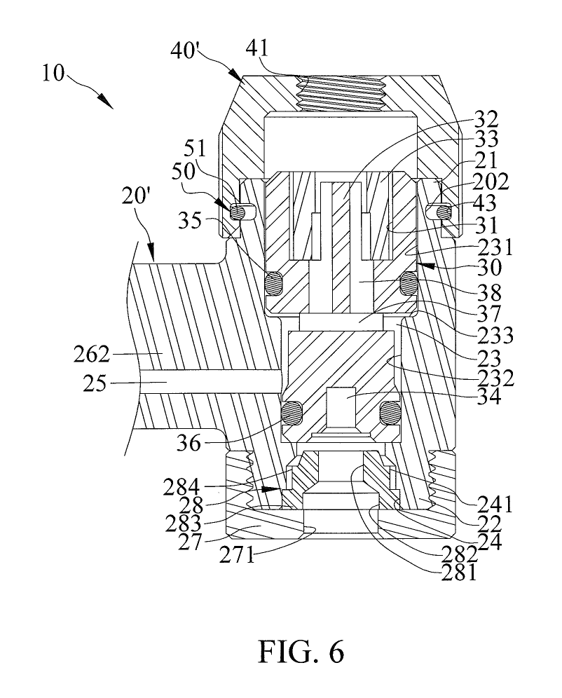

FIG. 6 is a nozzle head 10 in accordance with a second embodiment of the present invention. The second embodiment is different from the first embodiment in that a housing 20′ includes a periphery defining a first section and a cap 40′ includes a periphery defining a second section respectively, with the first and second sections abutted against each other circumferentially, with the first section including a first coupling end 202 defined thereon and the second section including a second coupling end 43 defined thereon respectively, with the first and second coupling ends 202 and 43 forming two slots. Also, the first section has a diameter larger than that of the second section.

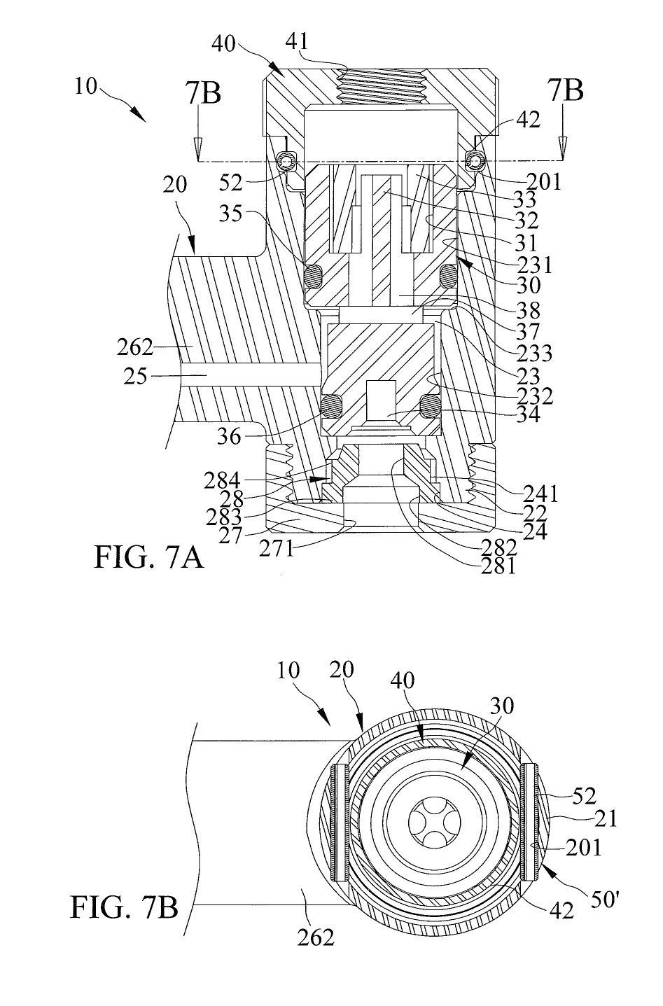

FIGS. 7A and 7B show a nozzle head 10 in accordance with a third embodiment of the present invention. The third embodiment is different from the first embodiment in that a fixing device 50, which is a shaft and partially received in the first and second coupling ends 201 and 42.

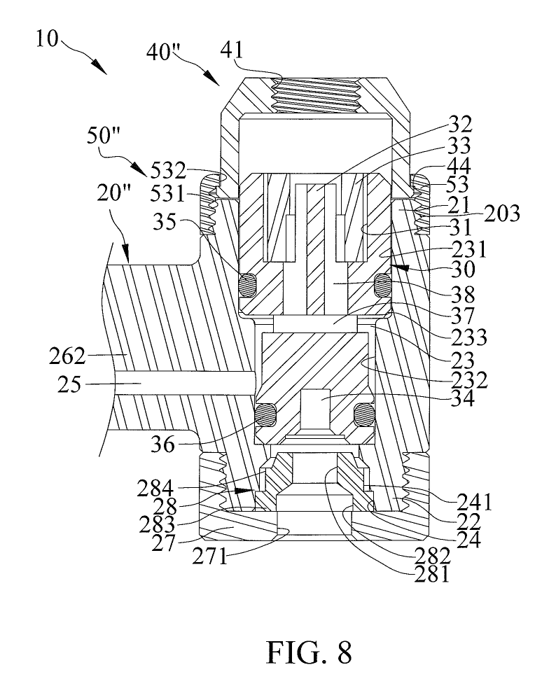

FIG. 8 is a nozzle head for an air pump in accordance with a fourth embodiment of the present invention. The fourth embodiment is different from the first embodiment in that a housing 20″ includes a periphery defining a first section and the cap 40″ includes a periphery defining a second section respectively, with the first and second sections disposed on top of each other, with the first section including a first coupling end 203 defined thereon and the second section including a second coupling end 44 defined thereon respectively, with the first coupling end 203 forming an outer thread and the second coupling end 44 forming a radially extended flange respectively, and a fixing device 50″, which is a sleeve 53 and encloses the first and second coupling ends 203 and 44 and includes a first catching end 531 forming a thread section engaging with the first coupling end 203 and a second catching end 532 forming a radially extended flange extending over the second coupling end 44.

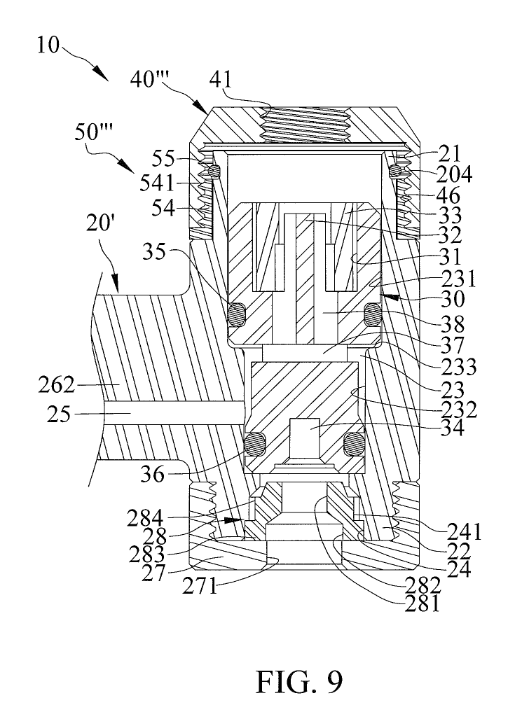

FIG. 9 is a nozzle head for an air pump in accordance with a fifth embodiment of the present invention. The fifth embodiment is different from the first embodiment in that the housing 20′ includes a periphery defining the first section and the cap 40′″ includes a periphery defining a second section respectively, with the first section surrounded circumferentially with respect to the second section, with the first section including the first coupling end 204 defined thereon and the second section including a second coupling end 40′″ defined thereon respectively, with the first coupling end 204 forming a slot and the second coupling end 40′″ forming a inner thread respectively, and a fixing device 50′″, which includes a rim 54 and a C-clip 55, with the rim 54 disposed between the first and second coupling ends 204 and 40′″ and including inner and outer peripheries abutted circumferentially against the first and second coupling ends 204 and 40′″, with the outer periphery of the rim 54 forming an outer thread 541, with the C-clip 55 received in the first coupling end 204 and restrained by the rim 55.

While the specific embodiments have been illustrated and described, numerous modifications come to mind without significantly departing from the spirit of invention, and the scope of invention is only limited by the scope of the accompanying claims.

What is claimed is:

1. A nozzle head for an air pump capable of engaging with different kinds of valves, comprising:
a housing including a first extension extended from a first end to a second end, and a second extension extending transversely from the first extension, with the first extension delimiting a first chamber extended therethrough, with the second extension delimiting a passage in fluid communication with the first chamber, with the housing engagable with a pumping mechanism of an air pump, which connects to the second extension, with the first chamber extended from the first end to the second end, with the first end adapted for receiving an American valve and the second end adapted for receiving a French valve, with the nozzle head and the American valve adapted to be airtightly engaged with each other in thread engagement, with the nozzle head and the French valve adapted to be airtightly engaged with each other in non-thread engagement;
an activating member disposed in the first chamber and movable axially therein and defining a first section and a second section, with the first and second sections for abutting against different valves, with the first section delimiting a second chamber, which includes a valve stem and an air seal disposed therein, with the valve stem adapted for abutting against the American valve and the air seal adapted to be pressed by the American valve and achieve an airtight effect, with the activating member movable to a first position in which the housing includes the first end in fluid communication with the passage and the second end not in fluid communication with the passage and a second position in which the housing includes the second end in fluid communication with the passage and the first end not in fluid communication with the passage; and
a cap fitted to the first end of the housing and rotatable with respect thereto, with the American valve in thread engagement with the cap.

2. The nozzle head as claimed in claim 1, wherein the cap and the housing include a fixing device engaged therebetween to prevent the housing and the cap from disengaging from each other.

3. The nozzle head as claimed in claim 2, wherein the housing includes a periphery defining a first section and the cap includes a periphery defining a second section respectively, with the first and second sections abutted against each other circumferentially, with the first section including a first coupling end defined thereon and the second section including a second coupling end defined thereon respectively, with the first and second coupling ends forming two slots.

4. The nozzle head as claimed in claim 3, wherein the fixing device is a c-ring, with the c-ring partially received in the first and second coupling ends.

5. The nozzle head as claimed in claim 3, wherein the fixing device is a shaft, with the shaft partially received in the first and second coupling ends.

6. The nozzle head as claimed in claim 2, wherein the housing includes a periphery defining a first section and the cap includes a periphery defining a second section respectively, with the first and second sections disposed on top of each other, with the first section including a first coupling end defined thereon and the second section including a second coupling end defined thereon respectively, with the first coupling end forming an outer thread and the second coupling end forming a radially extended flange respectively, wherein the fixing device is a sleeve, with the sleeve enclosing the first and second coupling ends and including a first catching end forming a thread section engaging with the first coupling end and a second catching end forming a radially extended flange extending over the second coupling end.

7. The nozzle head as claimed in claim 2, wherein the housing includes a periphery defining a first section and the cap includes a periphery defining a second section respectively, with the first section surrounded circumferentially with respect to the second section, with the first section including a first coupling end defined thereon and the second section including a second coupling end defined thereon respectively, with the first coupling end forming a slot and the second coupling end forming a inner thread respectively, wherein the fixing device includes a rim and a C-clip, with the rim disposed between the first and second coupling ends and including inner and outer peripheries abutted circumferentially against the first and second coupling ends, with the outer periphery of the rim forming an outer thread, with the C-clip received in the first coupling end and restrained by the rim.

8. The nozzle head as claimed in claim 1, wherein the first chamber defines a receiving section at the second end of the housing, with the receiving section receiving a seal ring, which is adapted for air-tightly surrounding and non-threadly engaging with the French valve, as well as allows the French valve to be able to be abutted against the second section of the activating member, wherein the seal ring delimits a throughhole for receiving the French valve and defines a fitting section and a restraining section, with the throughhole having a diametrical size smaller than that measuring an outer periphery of the French valve, with the fitting section abutted against a wall delimiting the receiving section and the restraining section spaced from the wall and defining a gap, with air being able to flow into the gap, thereby forcing the restraining section to depress the outer periphery of the French valve radially and enabling the French valve to be air-tightly surrounded and securely held by the seal ring.

9. The nozzle head as claimed in claim 8, wherein the housing includes a periphery defining a first section and the cap includes a periphery defining a second section respectively, with the first and second sections abutted against each other circumferentially, with the first section including a first coupling end defined thereon and the second section including a second coupling end defined thereon respectively, with the first and second coupling ends forming two slots.

10. The nozzle head as claimed in claim 9, wherein the fixing device is a c-ring, with the c-ring partially received in the first and second coupling ends.

11. The nozzle head as claimed in claim 9, wherein the fixing device is a shaft, with the shaft partially received in the first and second coupling ends.

12. The nozzle head as claimed in claim 8, wherein the housing includes a periphery defining a first section and the cap includes a periphery defining a second section respectively, with the first and second sections disposed on top of each other, with the first section including a first coupling end defined thereon and the second section including a second coupling end defined thereon respectively, with the first coupling end forming an outer thread and the second coupling end forming a radially extended flange respectively, wherein the fixing device is a sleeve, with the sleeve enclosing the first and second coupling ends and including a first catching end forming a thread section engaging with the first coupling end and a second catching end forming a radially extended flange extending over the second coupling end.

13. The nozzle head as claimed in claim 8, wherein the housing includes a periphery defining a first section and the cap includes a periphery defining a second section respectively, with the first section surrounded circumferentially with respect to the second section, with the first section including a first coupling end defined thereon and the second section including a second coupling end defined thereon respectively, with the first coupling end forming a slot and the second coupling end forming a inner thread respectively, wherein the fixing device includes a rim and a C-clip, with the rim disposed between the first and second coupling ends and including inner and outer peripheries abutted circumferentially against the first and second coupling ends, with the outer periphery of the rim forming an outer thread, with the C-clip received in the first coupling end and restrained by the rim.

14. The nozzle head as claimed in claim 1 further comparing a cover fitted to the second end of the housing and delimiting a first aperture adapted for an insertion of the French valve, wherein the cap delimits a second aperture with a threaded periphery adapted for threadly receiving the American valve, wherein the first and second apertures are in fluid communication with the second chamber.

15. The nozzle head as claimed in claim 1, wherein the first chamber defines larger and smaller chamber sections, with the larger chamber section larger in diametrical size than the smaller chamber section, with a stop wall extending from a periphery of the larger chamber section to a periphery of the smaller chamber section, wherein the activating member includes the first section received in the larger chamber section and the second section received in the smaller chamber section respectively, with the first section shorter in length than the larger chamber section, with the first section larger in diametrical size than the second section, with a shoulder formed and extending from a periphery of the first section to a periphery of the second section, with the shoulder abutted against the stop wall to stop the first section from trespassing into the smaller chamber section.

16. The nozzle head as claimed in claim 8, wherein section of the through hole of the seal ring delimited by the restraining section defines a first hole section adapted for surrounding a neck of the French valve, which separates smaller and larger outer peripheral sections of the French valve, with the smaller outer peripheral section defining a thread section, with the first hole section extending in a first direction and having a first longitudinal length greater than that measuring a longitudinal length of the neck.

17. The nozzle head as claimed in claim 16, wherein the restraining section of the seal ring has a second longitudinal length in the first direction, with the second longitudinal length greater than the first longitudinal length.
